(19) United States
(12) Patent Application Publication
(10) Pub. No.: US 2026/0167506 A1
(43) Pub. Date: Jun. 18, 2026

(54) METHOD FOR THE PREPARATION OF HIGH-PURITY CRISTOBALITE

(71) Applicant: ANHUI ESTONE MATERIAL TECHNOLOGY CO., LTD., Bengbu (CN)

(72) Inventors: Xuexin JIANG, Bengbu (CN); Bo CHEN, Bengbu (CN)

(73) Assignee: ANHUI ESTONE MATERIAL TECHNOLOGY CO., LTD, Bengbu (CN)

(21) Appl. No.: 18/716,945

(22) PCT Filed: Mar. 25, 2024
(86) PCT No.: PCT/CN2024/083450

§ 371 Date: Jun. 6, 2024

(30) Foreign Application Priority Data
Aug. 7, 2023 (CN) 202310980924. 1

(51) Int. Cl. C01B 33/18

(52) U.S. Cl. CPC C01B 33/181; C01P 2002/72; C01P 2002/82; C01P 2004/62; C01P 2004/64; C01P 2006/80

(57) ABSTRACT

A method for the preparation of high-purity cristobalite is provided. The method involves obtaining high-purity cristobalite by drying, calcining, and dispersing amorphous silica. In comparison with existing technologies, the beneficial effects of the present invention are as follows: 1. Amorphous silica has a large specific surface area and is rich in hydroxyl groups. Therefore, the cristobalite transformed from amorphous silica is prone to have pores. To eliminate these pores, the present invention employs a coupling agent for surface treatment followed by calcination. 2. The inventor chooses the silane coupling agent with a short chain length under the same mass, reducing the pores in cristobalite. Moreover, there is a certain reduction in calcination temperature and time. The possible reason is that the silane coupling agent decomposes at high temperatures, forming silica. Due to the small particle size of the decomposed silica, it preferentially forms nuclei, promoting the overall crystalline transformation.

### CROSS REFERENCE TO THE RELATED APPLICATIONS

This application is the national phase entry of International Application No. PCT/CN2024/083450, filed on Mar. 25, 2024, which is based upon and claims priority to Chinese Patent Application No. 202310980924.1, filed on Aug. 7, 2023, the entire contents of which are incorporated herein by reference.

### TECHNICAL FIELD

The present invention pertains to the technical field of quartz sand, particularly focusing on a method for the preparation of high-purity cristobalite.

### BACKGROUND

Quartz (SiO₂) is an oxide of silicon with a framework structure, having various homogenous variants. At atmospheric pressure, there are seven crystal types: α-quartz, β-quartz, α-tridymite, β1-tridymite, β-tridymite, α-cristobalite, and β-cristobalite. Their transition temperatures are illustrated in FIG. 4. Among them, β-type represents the stable crystal type at high temperatures, while α-type represents the stable crystal type at low temperatures. Quartz is widely distributed in nature, and unless specifically stated, the term “quartz” typically refers to α-quartz.

High-purity quartz sand generally refers to quartz with a silica content greater than 99.9%. Based on SiO₂ purity, high-purity quartz products can be classified into four grades: high-end ω (SiO₂)≥99.998% (4N8), mid-high ω (SiO₂)≥99.995% (4N5), mid-range ω (SiO₂)≥99.99% (4N), and low-end ω (SiO₂)≥99.9% (3N) (refer to “Concept and Classification of High-Purity Quartz Raw Materials,” Conservation and Utilization of Mineral Resources, October 2022, Issue 5). However, untreated natural quartz is challenging to meet the quality requirements of high-purity quartz. In other words, high-purity quartz sand is derived from natural quartz deposits and processed through a complex purification process to achieve extremely high SiO₂ purity. In addition, due to constraints in subsequent product preparation processes, high-purity quartz sand has strict requirements for particle size (typically 40-200 mesh) and mineral phases. Therefore, commonly mentioned silicon powders, white carbon blacks, and other amorphous silicas, even with high purity, do not qualify as high-purity quartz sand.

Impurity elements in natural quartz sand mainly include Al, K, Na, Li, Ca, Cu, B, Fe, Mn, Co, Ti, P, etc. Among these impurity elements, monovalent and divalent ions exist in the quartz lattice as charge-compensating defects in the form of interstitial atoms. Trivalent, tetravalent, and pentavalent ions (homologous impurities) primarily exist within the lattice. To remove impurities from quartz sand, various processes have been proposed, as documented by Zhang Haiqi et al. in the paper “Characteristics of Impurities in High-Purity Quartz and Progress in Deep Chemical Purification Technology” (Conservation and Utilization of Mineral Resources, August 2022, Issue 4). The paper details existing purification technologies for quartz sand, emphasizing two main methods: physical and chemical. Physical purification involves processes such as color sorting, scrubbing, reselection, magnetic separation, and flotation. However, gas-liquid inclusions and intralattice homologous impurities are the main sources of impurities, and physical purification cannot eliminate these impurities, calling for chemical purification. Chemical deep purification mainly includes acid (alkali, salt) treatment and heat treatment. Acid (alkali, salt) treatment primarily removes impurities on the surface or embedded within quartz sand particles in the form of gas-liquid inclusions, while heat treatment utilizes high temperatures to crack enclosures, reducing gas-liquid impurities (not completely removed).

Compared to physical purification methods, chemical purification operations are complex and costly but are the most effective and essential in preparing high-purity quartz.

However, there are the following problems in the existing technology:

1) Quartz stone needs to undergo multiple steps such as acid washing, flotation, magnetic separation, reselection, high-temperature water quenching, and chloride roasting before being processed into high-purity quartz sand. The process is lengthy, and acid washing for impurity removal is inefficient and complex, easily introducing exogenous impurities such as iron, sodium, aluminum, etc.

2) The hydrofluoric acid, hydrochloric acid, and nitric acid used in acid washing have high concentrations and large quantities, leading to the generation of a significant amount of wastewater containing fluorine and chlorine during acid washing, increasing processing costs.

In the study “Thermal Kinetic Desorption of Gas-Liquid Impurities in Natural Quartz” by Jiang Xuexin et al. (Journal of the Chinese Ceramic Society, October 2004), a thorough investigation into the impact of impurities in quartz on quartz products is conducted. It is found that impurities in quartz on quartz products is conducted. It is found that quartz sand, due to the presence of gas-liquid inclusions and a high content of hydroxyl groups on the surface (generally above 80 ppm), tends to produce bubbles during the manufacturing of quartz products, affecting product quality.

### SUMMARY

To address the issues mentioned in the background art above, the present invention provides a method for preparing high-purity cristobalite, obtaining high-purity cristobalite by drying, calcining, and dispersing amorphous silica.

Preferably, the amorphous silica includes but is not limited to that obtained through the oxidation of metallic silicon.

The oxidation of metallic silicon includes the combustion of metallic silicon, or the high-temperature reaction of metallic silicon with high-purity water, or the conversion of metallic silicon into silicon-containing organic compounds, such as silane, followed by calcination to transform into any one of various forms of amorphous nano-silica.

Preferably, the particle size of the amorphous silica is in the range of 5 nanometers to 1 micron.

Preferably, the drying conditions are as follows: treatment at 100° C. to 150° C. for 1 to 2 hours.

Preferably, the calcination conditions are as follows: treatment at 1100° C. to 1700° C. for 2 to 10 hours.

Preferably, the particle size of the high-purity cristobalite is in the range of 120 to 450 microns.

Preferably, the total content of elements Al, B, Ca, Cr, Cu, Fe, K, Li, Mg, Mn, Na, Ni, P, Ti, Zn in the high-purity cristobalite is less than 20 ppm.

Preferably, after drying, the process includes a step of using a coupling agent for treatment.

Preferably, the coupling agent is selected from silane coupling agents and titanate coupling agents.

Preferably, to reduce the introduction of impurities, the silane coupling agent is one containing only carbon, silicon, hydrogen, and oxygen elements.

Preferably, the silane coupling agent containing only carbon, silicon, hydrogen, and oxygen elements has a carbon chain length not exceeding 5.

In comparison with existing technologies, the beneficial effects of the present invention are as follows:

1. Amorphous silica has a large specific surface area and is rich in hydroxyl groups. Therefore, the cristobalite transformed from amorphous silica is prone to have pores. To eliminate these pores, the present invention employs a coupling agent for surface treatment followed by calcination. Data shows a significant reduction in hydroxyl groups.

2. Under the same mass of coupling agent, the inventor chooses a silane coupling agent with a short chain length, resulting in fewer pores in cristobalite. Additionally, there is a certain reduction in calcination temperature and time. The possible reason is that the silane coupling agent decomposes at high temperatures, forming silica. Due to the small particle size of the decomposed silica, it preferentially forms nuclei, promoting the overall crystalline transformation.

3. The high-purity cristobalite obtained by the invention has fewer hydroxyl groups compared to existing high-purity quartz, except for elements such as Al, B, Ca, Cr, Cu, Fe, K, Li, Mg, Mn, Na, Ni, P, Ti, Zn.

4. The use of silane coupling agent treatment in the present invention reduces the pores in cristobalite, as well as the calcination temperature and time, leading to energy savings.

### BRIEF DESCRIPTION OF THE DRAWINGS

FIG. 1 is the XRD graph of high-purity cristobalite in Example 7.

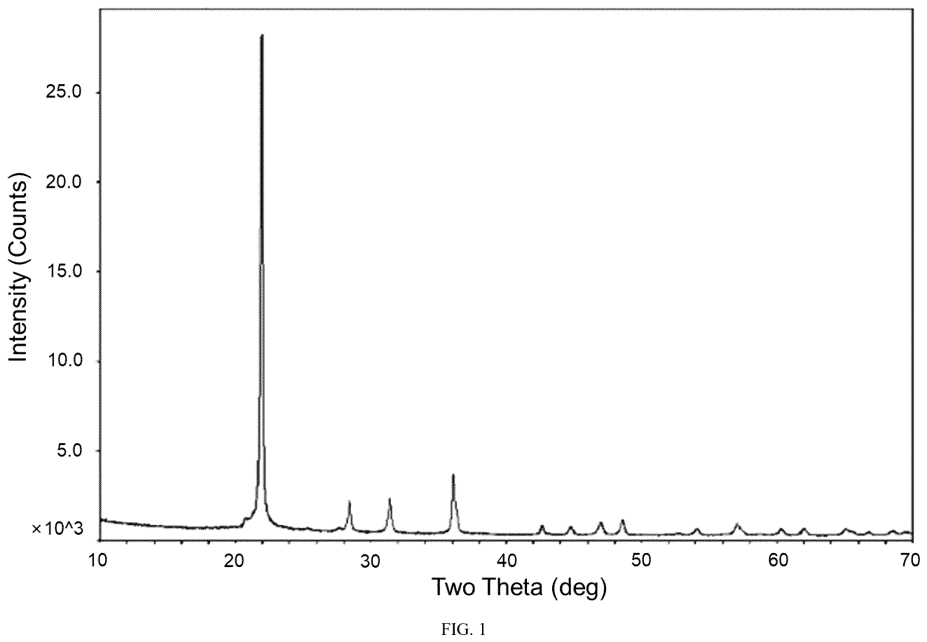

FIG. 2 is the infrared spectrum of amorphous silica A.

FIG. 3 is the infrared spectrum of high-purity cristobalite in Example 7.

FIG. 4 is the graph of atmospheric transition temperatures between various crystal types of silica.

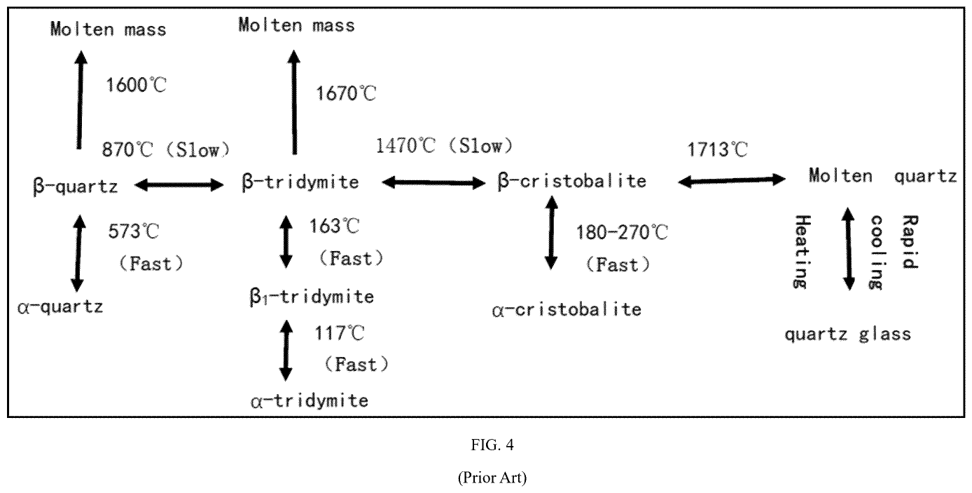

### DETAILED DESCRIPTION OF THE EMBODIMENTS

Unless otherwise specified, the raw materials and reagents used in the following examples are commercially available or can be prepared by known methods.

The particle size of the amorphous silica in the present invention is in the range of 5 nanometers to 1 micron, with a specific surface area of 90 to 200 m²/g. The source can be purchased from the market, such as Aladdin, or prepared by the following method.

Photovoltaic-grade polycrystalline silicon is burned in oxygen under controlled conditions to obtain high-purity amorphous silica with different particle sizes.

In the present invention, amorphous silica (particle size 5 nanometers, specific surface area 200 m²/g) is labeled as amorphous silica A.

Amorphous silica (particle size 10 nanometers, specific surface area 150 m²/g) is labeled as amorphous silica B.

Amorphous silica (particle size 1 micron, specific surface area 90 m²/g) is labeled as amorphous silica C.

### Example 1

Amorphous silica A is dried at 100° C. for 2 hours, calcined at 1170° C. for 10 hours, naturally cooled, and dispersed with airflow to obtain high-purity cristobalite with a particle size of 120 microns.

### Example 2

Amorphous silica A is dried at 150° C. for 1 hour, calcined at 1700° C. for 2 hours, naturally cooled, and dispersed with airflow to obtain high-purity cristobalite with a particle size of 200 microns.

### Example 3

Amorphous silica B is dried at 100° C. for 2 hours, calcined at 1170° C. for 10 hours, naturally cooled, and dispersed with airflow to obtain high-purity cristobalite with a particle size of 380 microns.

### Example 4 (Demonstrating the Result of Preparing High-Purity Cristobalite from Micron-Level Raw Materials)

Amorphous silica C is dried at 100° C. for 2 hours, calcined at 1170° C. for 10 hours, naturally cooled, and dispersed with airflow to obtain high-purity cristobalite with a particle size of 630 microns.

### Example 5

Amorphous silica A (3 kg) is dried at 100° C. for 2 hours. A modified liquid is obtained by mixing 30 g of coupling agent (CH₃O)₃Si(CH₂)₁₀CH₃ with 100 g of ethanol. The modified liquid is mixed uniformly with the dried amorphous silica, dried at 100° C. for 2 hours, and then calcined at 1170° C. for 10 hours. The resulting high-purity cristobalite has a particle size of 180 microns.

### Example 6

Amorphous silica A (3 kg) is dried at 100° C. for 2 hours. A modified liquid is obtained by mixing 30 g of coupling agent (CH₃O)₃Si(CH₂)₁₀CH₃ with 100 g of ethanol. The modified liquid is mixed uniformly with the dried amorphous silica, dried at 100° C. for 2 hours, and then calcined at 1170° C. for 10 hours. The resulting high-purity cristobalite has a particle size of 157 microns.

### Example 7

Amorphous silica A (3 kg) is dried at 100° C. for 2 hours. A modified liquid is obtained by mixing 30 g of coupling agent (CH₃O)₃Si(CH₂)₁₀CH₃ with 100 g of ethanol. The modified liquid is mixed uniformly with the dried amorphous silica, dried at 100° C. for 2 hours, and then calcined at 1170° C. for 6 hours. The resulting high-purity cristobalite has a particle size of 135 microns.

### Comparative Example 1

Amorphous silica A (3 kg) is dried at 100° C. for 2 hours. A modified liquid is obtained by mixing 30 g of coupling agent (CH₃O) 3 Si(CH₂)—CH₃ with 100 g of ethanol. The modified liquid is mixed uniformly with the dried amorphous silica, dried at 100° C. for 2 hours, and then calcined at 1170° C. for 8 hours. The resulting high-purity cristobalite has a particle size of 163 microns.

### Comparative Example 2

The high-purity quartz ITOA-6 from US Unimin Corporation is dried at 100° C. for 2 hours and calcined at 1170° C. for 10 hours. The resulting high-purity cristobalite has a particle size of 230 microns.

### Results and Testing

ICP-OES is used to test impurity ions in the obtained samples (detection limit is 1 ppb), and the results are shown in Table 1.

TABLE 1
Impurity Ion Test Results for Raw Materials and Example Samples (Unit: ppm)

| | Al | B | Ca | Cr | Cu | Fe | K | Li | Mg | Mn | Na | Ni | P | Ti | Zn | Total |
|---|---|---|---|---|---|---|---|---|---|---|---|---|---|---|---|---|
| Amorphous | 0.544 | ND | 0.5 | 0.015 | 0.014 | 0.065 | 0.301 | 0.215 | 0.015 | 0.099 | 0.103 | ND | ND | 0.932 | 0.281 | 2.45 |
| Silica A | | | | | | | | | | | | | | | | |
| Amorphous | 0.287 | 0.001 | 0.024 | ND | ND | 0.012 | 0.251 | 0.205 | 0.016 | 0.011 | 0.256 | ND | ND | 0.953 | 0.874 | 2.89 |
| Silica B | | | | | | | | | | | | | | | | |
| Amorphous | 0.272 | 0.021 | 0.04 | ND | ND | 0.03 | 0.208 | 0.306 | 0.005 | 0.035 | 0.173 | ND | ND | 0.823 | 0.765 | 2.678 |
| Silica C | | | | | | | | | | | | | | | | |
| Example 1 | 0.752 | 0.052 | 0.513 | ND | ND | 0.043 | 0.315 | 0.181 | 0.057 | 0.083 | 0.045 | ND | ND | 0.956 | 0.297 | 3.294 |
| Example 2 | 0.612 | 0.042 | 0.512 | ND | ND | 0.045 | 0.329 | 0.098 | 0.058 | 0.124 | 0.184 | ND | ND | 0.811 | 0.543 | 3.358 |
| Example 3 | 0.747 | 0.022 | 0.557 | ND | ND | 0.041 | 0.353 | 0.195 | 0.036 | 0.092 | 0.084 | ND | ND | 0.755 | 0.396 | 3.278 |
| Example 4 | 0.654 | 0.035 | 0.566 | ND | ND | 0.048 | 0.356 | 0.174 | 0.069 | 0.119 | 0.131 | ND | ND | 0.958 | 0.562 | 3.672 |
| Example 5 | 0.129 | ND | 0.285 | 0.124 | 0.02 | 0.012 | 0.417 | ND | ND | ND | 0.069 | ND | ND | 0.897 | 0.728 | 2.681 |
| Example 6 | 0.212 | 0.018 | 0.408 | ND | ND | 0.027 | 0.268 | 0.122 | 0.016 | 0.048 | 0.218 | ND | ND | 0.971 | 0.867 | 3.175 |
| Example 7 | 0.208 | 0.014 | 0.416 | ND | ND | 0.030 | 0.258 | 0.091 | 0.005 | 0.051 | 0.023 | ND | ND | 0.983 | 0.857 | 2.936 |
| Comparative | 0.751 | ND | 0.856 | 0.347 | 0.061 | 0.053 | 0.408 | 0.264 | 0.013 | 0.159 | 0.165 | ND | ND | 0.675 | 0.245 | 3.997 |
| Example 1 | | | | | | | | | | | | | | | | |
| Comparative | 0.204 | ND | 0.315 | 0.141 | 0.031 | 0.015 | 0.306 | ND | ND | ND | 0.064 | ND | ND | 0.829 | 0.387 | 2.292 |
| Example 2 | | | | | | | | | | | | | | | | |

The samples are measured for particle size, porosity, and crystallinity. Nitrogen adsorption-desorption is used for pore measurement, a particle size analyzer for particle size measurement, and XRD for crystallinity measurement, as shown in Table 2.

TABLE 2

| | Particle | Porosity | | Content |
|---|---|---|---|---|
| | Size (nm) | (%) | Crystallinity | (%) |
| Example 1 | 120 | 0.63 | 94% | 99.9997 |
| Example 2 | 200 | 0.62 | 97% | 99.9997 |
| Example 3 | 380 | 0.60 | 92% | 99.9997 |
| Example 4 | 630 | 0.61 | 95% | 99.9996 |
| Example 5 | 180 | 0.28 | 98% | 99.9997 |
| Example 6 | 157 | 0.29 | 97% | 99.9997 |
| Example 7 | 135 | 0.24 | 98% | 99.9997 |
| Comparative | 163 | 0.30 | 91% | 99.9996 |
| Example 1 | | | | |
| Comparative | 230 | 0.42 | 96% | 99.9998 |
| Example 2 | | | | |

Table 3 shows the hydroxyl group content (in ppm) in materials before and after coupling agent treatment of Examples 5-7. The hydroxyl group content is calculated based on infrared spectra. The results are shown in Table 3.

TABLE 3

| | Hydroxyl Group | Hydroxyl Group | |
|---|---|---|---|
| | Content in | Content in | Hydroxyl Group |
| | Materials Before | Materials After | Content in |
| | Coupling Agent | Coupling Agent | Resulting |
| | Treatment | Treatment | Cristobalite |
| Example 5 | 510 | 12 | 1 |
| Example 6 | 640 | 15 | 2 |
| Example 7 | 432 | 18 | 4 |

Data Analysis: From Table 1, it can be seen that compared with the raw materials, there is a certain increase in impurity content in the products, possibly due to unavoidable contamination during the preparation process.

In Table 2, for materials treated with coupling agents, the porosity significantly decreases after high-temperature calcination. Compared between Example 6 and Example 7, the use of a long-chainsilane coupling agent results in a relatively high porosity, and the use of a short-chain silane coupling agent achieves a higher crystallinity in a shorter time, making it more energy-efficient.

After coupling agent treatment, the hydroxyl group content in the materials (Table 3) significantly decreases, and in the resulting cristobalite, the hydroxyl group content further decreases.

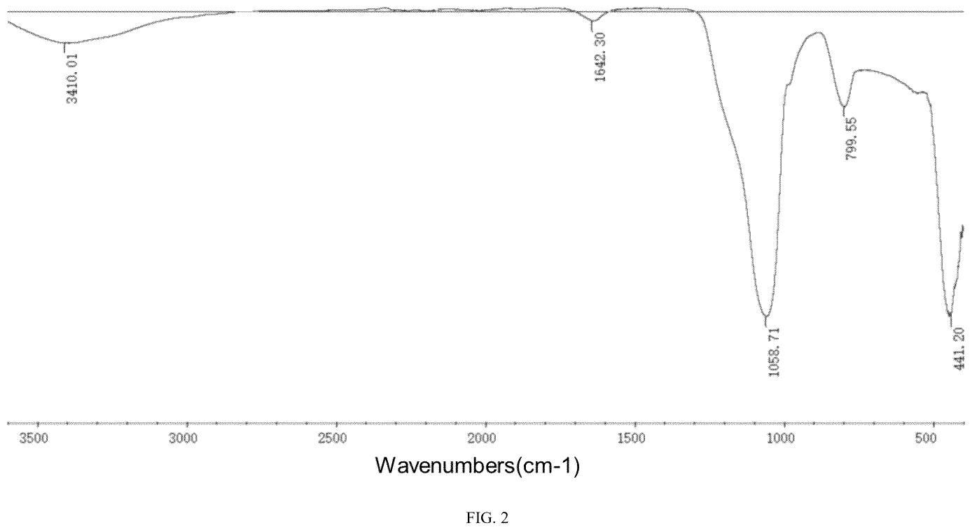

FIG. 2 is the infrared spectrum of the high-purity amorphous silica raw material, showing vibration peaks at 3410 cm⁻¹ and 1642 cm⁻¹, indicating the presence of hydroxyl groups on its surface.

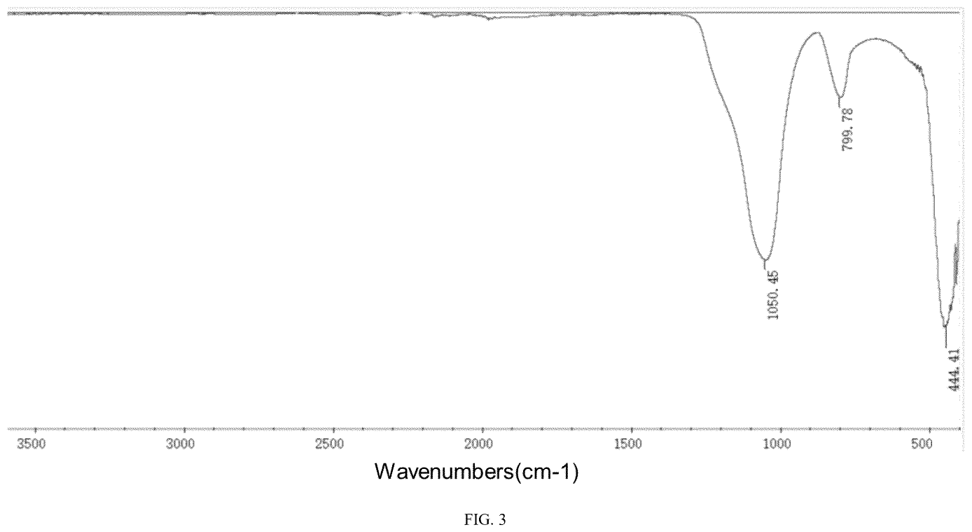

FIG. 3 is the infrared spectrum of the cristobalite, showing no vibration peaks at 3410 cm⁻¹ and 1642 cm⁻¹, indicating the absence of hydroxyl groups on its surface.

The above-described embodiments are merely preferred examples of the present invention, and the scope of protection of the present invention is not limited thereto. Any person skilled in the art, within the technical scope disclosed by the present invention, can make equivalent substitutions or changes based on the technical solution of the present invention and its inventive concept. All should be covered within the scope of protection of the present invention.

What is claimed is:

1. A method for a preparation of a high-purity cristobalite, comprising obtaining the high-purity cristobalite by drying, calcining, and dispersing an amorphous silica.

2. The method for the preparation of the high-purity cristobalite according to claim 1, wherein the amorphous silica is obtained through an oxidation of a metallic silicon.

3. The method for the preparation of the high-purity cristobalite according to claim 2, wherein the metallic silicon is oxidized by burning, or the metallic silicon reacts at high temperatures with high-purity water, or the metallic silicon is transformed into silicon-containing organic compounds, followed by a calcination to transform into one of an amorphous nano-sized silica, the silicon-containing organic compounds comprise silane.

4. The method for the preparation of the high-purity cristobalite according to claim 1, wherein a particle size of the amorphous silica is 5 nanometers to 1 micron.

5. The method for the preparation of the high-purity cristobalite according to claim 1, wherein the amorphous silica is dried at 100° C. to 150° C. for 1 to 2 hours.

6. The method for the preparation of the high-purity cristobalite according to claim 1, wherein the amorphous silica is calcined at 1100° C. to 1700° C. for 2 to 10 hours.

7. The method for the preparation of the high-purity cristobalite according to claim 1, wherein a particle size of the high-purity cristobalite is 120 to 450 microns.

8. The method for the preparation of the high-purity cristobalite according to claim 1, wherein a total content of elements Al, B, Ca, Cr, Cu, Fe, K, Li, Mg, Mn, Na, Ni, P, Ti, and Zn in the high-purity cristobalite is less than 20 ppm.

9. The method for the preparation of the high-purity cristobalite according to claim 1, wherein after the drying, the method further comprises a step of treating with a coupling agent.

10. The method for the preparation of the high-purity cristobalite according to claim 9, wherein the coupling agent is selected between a silane coupling agent and a titanate coupling agent.

11. The method for the preparation of the high-purity cristobalite according to claim 10, wherein the silane coupling agent comprises only carbon, silicon, hydrogen, and oxygen elements.

12. The method for the preparation of the high-purity cristobalite according to claim 11, wherein the silane coupling agent has a carbon chain length not exceeding 5.
